(19) United States
(12) Patent Application Publication
(10) Pub. No.: US 2021/0210831 A1
(43) Pub. Date: Jul. 8, 2021

(54) SPLIT-RING RESONATOR AND BOARD

(71) Applicant: Japan Aviation Electronics Industry, Limited, Tokyo (JP)

(72) Inventors: Keishi KOSAKA, Tokyo (JP); Hiroshi TOYAO, Tokyo (JP); Eiji HANKUI, Tokyo (JP); Yasuhiko MATSUNAGA, Tokyo (JP)

(73) Assignee: Japan Aviation Electronics Industry, Limited, Tokyo (JP)

(21) Appl. No.: 17/057,221

(22) PCT Filed: May 28, 2019
(86) PCT No.: PCT/JP2019/021069

§ 371 Date: Nov. 20, 2020

(30) Foreign Application Priority Data
Jun. 4, 2018 (JP) 2018-106627

(51) Int. Cl. H01P 7/08; H01Q 13/10; H01Q 9/04

(52) U.S. Cl. CPC H01P 7/08; H01Q 9/045; H01Q 13/10

(57) ABSTRACT

This split-ring resonator comprises, for example, a ground terminal cut-out from a ground pattern, wherein the ground terminal includes a section that extends in a direction that is substantially perpendicular to a surface that belongs to a split-ring-shaped conductor section of the split-ring resonator.

### TECHNICAL FIELD

This invention relates to a split-ring resonator and a board.

### BACKGROUND ART

An antenna with a split-ring resonator is known as a compact antenna used in a wireless communication device. For example, Patent Document 1 discloses a wireless communication device comprising a split-ring resonator.

### PRIOR ART DOCUMENTS

### Patent Document(s)

Patent Document 1: WO 2013/027824

### SUMMARY OF INVENTION

### Technical Problem

The split-ring resonator of Patent Document 1 is directly drawn on a ground pattern of a board. Therefore, according to the aspect disclosed in Patent Document 1, the split-ring resonator neither can be distributed as a single component nor can be flexibly combined in accordance with design requirements. Thus, according to the aspect disclosed in Patent Document 1, the split-ring resonator cannot be used as a component.

### Solution to Problem

For example, a split-ring resonator according to an aspect of the present disclosure may comprise a ground terminal separated from a ground pattern, and the ground terminal may include a part extending in a substantially perpendicular direction relative to a plane which belongs to a split-ring like conductive portion of the split-ring resonator. For example, a board according to an aspect of the present disclosure may comprise a terminal which corresponds to a ground terminal of a split-ring resonator according to an aspect of the present disclosure.

### Advantageous Effects of Invention

For example, according to various aspects of the present disclosure, a split-ring resonator can be used as a component.

### BRIEF DESCRIPTION OF DRAWINGS

FIG. 1 is an example of a split-ring resonator according to an aspect of the present disclosure.

FIG. 2 is an example of a split-ring resonator according to an aspect of the present disclosure.

FIG. 3 is an example of a split-ring resonator according to an aspect of the present disclosure.

FIG. 4 is an example of a split-ring resonator according to an aspect of the present disclosure.

FIG. 5 is an example of a split-ring resonator according to an aspect of the present disclosure.

FIG. 6 is an example of a split-ring resonator according to an aspect of the present disclosure.

FIG. 7 is an example of a split-ring resonator according to an aspect of the present disclosure.

FIG. 8 is an example of a split-ring resonator according to an aspect of the present disclosure.

FIG. 9 is an example of a split-ring resonator according to an aspect of the present disclosure.

FIG. 10 is an example of a split-ring resonator according to an aspect of the present disclosure.

FIG. 11 is an example of a split-ring resonator according to an aspect of the present disclosure.

FIG. 12 is an example of a split-ring resonator according to an aspect of the present disclosure.

FIG. 13 is an example of a split-ring resonator according to an aspect of the present disclosure.

FIG. 14 is an example of a split-ring resonator according to an aspect of the present disclosure.

FIG. 15 is an example of a split-ring resonator according to an aspect of the present disclosure.

FIG. 16 is an example of a split-ring resonator according to an aspect of the present disclosure.

FIG. 17 is an example of a split-ring resonator according to an aspect of the present disclosure.

FIG. 18 is an example of a split-ring resonator according to an aspect of the present disclosure.

FIG. 19 is an example of a split-ring resonator according to an aspect of the present disclosure.

FIG. 20 is an example of a split-ring resonator according to an aspect of the present disclosure.

FIG. 21 is an example of a split-ring resonator according to an aspect of the present disclosure.

FIG. 22 is an example of a split-ring resonator according to an aspect of the present disclosure.

FIG. 23 is an example of a split-ring resonator according to an aspect of the present disclosure.

FIG. 24 is an example of a split-ring resonator according to an aspect of the present disclosure.

FIG. 25 is an example of a split-ring resonator according to an aspect of the present disclosure.

FIG. 26 is an example of a split-ring resonator according to an aspect of the present disclosure.

FIG. 27 is an example of a split-ring resonator according to an aspect of the present disclosure.

FIG. 28 is an example of a board according to an aspect of the present disclosure.

FIG. 29 is an example of a board according to an aspect of the present disclosure.

FIG. 30 is an example of a board according to an aspect of the present disclosure.

FIG. 31 is an example of a connection configuration of an example of a board according to an aspect of the present disclosure with an example of a split-ring resonator according to an aspect of the present disclosure.

FIG. 32 is an example of a connection configuration of an example of a board according to an aspect of the present disclosure with an example of a split-ring resonator according to an aspect of the present disclosure.

FIG. 33 is an example of a connection configuration of an example of a board according to an aspect of the present disclosure with an example of a split-ring resonator according to an aspect of the present disclosure.

FIG. 34 is an example of a board according to an aspect of the present disclosure.

FIG. 35 is an example of a board according to an aspect of the present disclosure.

FIG. 36 is an example of a connection configuration of an example of a board according to an aspect of the present disclosure with an example of a split-ring resonator according to an aspect of the present disclosure.

FIG. 37 is an example of a board according to an aspect of the present disclosure.

FIG. 38 is an example of a connection configuration of an example of a board according to an aspect of the present disclosure with an example of a split-ring resonator according to an aspect of the present disclosure.

FIG. 39 is an example of a connection configuration of an example of a board according to an aspect of the present disclosure with an example of a split-ring resonator according to an aspect of the present disclosure.

FIG. 40 is an example of a split-ring resonator according to an aspect of the present disclosure.

### DESCRIPTION OF EMBODIMENTS

All aspects according to the present disclosure are merely examples, and they are neither intended to exclude the other examples from the present disclosure nor intended to limit technical features of the invention described in Claims.

The description about combinations of the aspects according to the present disclosure may be partially omitted. Such omissions are intended to simplify the description, and they are neither intended to exclude them from the present disclosure nor intended to limit the technical scope of the invention described in Claims. All combinations of the aspects according to the present disclosure are included in the present disclosure either explicitly, implicitly or inherently with or without such omissions. Thus, all combinations of the aspects according to the present disclosure can be directly and clearly conceived from the present disclosure with or without such omission.

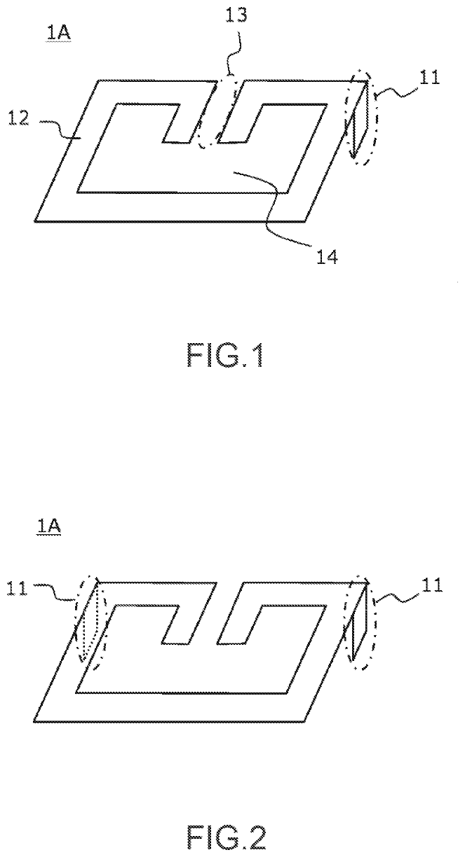

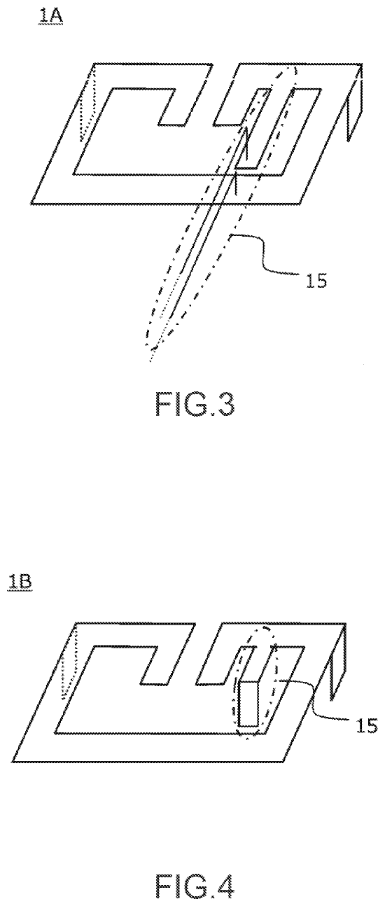

For example, a split-ring resonator according to an aspect of the present disclosure may comprise a ground terminal 11 separated from a ground pattern, and the ground terminal 11 may include a part extending in a substantially perpendicular direction relative to a plane which belongs to a split-ring like conductive portion of the split-ring resonator. FIG. 1 is an example of a split-ring resonator according to an aspect of the present disclosure. FIG. 2 is an example of a split-ring resonator according to an aspect of the present disclosure. FIG. 3 is an example of a split-ring resonator according to an aspect of the present disclosure.

Hereafter, the plane belonging to the split-ring resonator of the split-ring like conductive portion is referred to as “plane P”. Hereafter, the substantially perpendicular direction relative to the plane P is referred to as “D-direction”.

For example, a split-ring resonator 1A may comprise a split-ring conductor 12, a split 13 and an opening 14. For example, the split-ring resonator 1A may comprise a plurality of the ground terminals 11. For example, the split-ring resonator 1A may comprise a feeding wire 15.

For example, the split-ring conductor 12 may be a split-ring like conductive portion of the split-ring resonator 1A. For example, the split-ring conductor 12 may be formed of a metal plate. For example, the split-ring conductor 12 may have any shape. For example, the split-ring conductor 12 may have a shape based on a C-like shape along a rectangular ring. For example, the split-ring conductor 12 may have a shape based on the other various rings such as a circular ring, an elliptical ring, and a track ring.

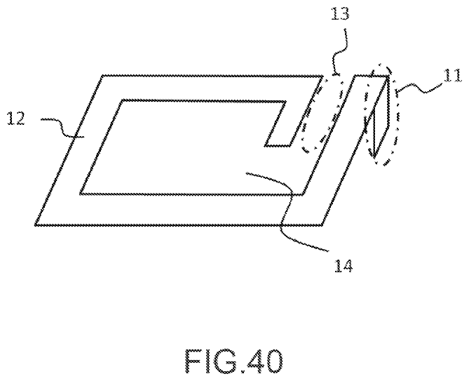

For example, the split 13 may be filled with nothing. For example, the split 13 may be filled with resin. For example, the split 13 may have any shape. For example, the split 13 may have a shape such as a straight line, a curved line, or a zigzag line. FIG. 40 is an example of a split-ring resonator according to an aspect of the present disclosure. For example, the position of the split 13 is not limited to that shown in FIG. 1, etc. but may be the position shown in FIG. 40.

For example, the opening 14 may be enclosed by the split-ring 12 and the split 13. For example, the opening 14 may have any shape. For example, the opening 14 may have a polygonal shape such as a square or a rectangle or may have a shape such as a circle or an ellipse.

For example, the ground terminal 11 may have any structure, provided that the structure allows electrical connection with a ground pattern. For example, the ground terminal 11 may be formed of a metal plate. For example, the ground terminal 11 may include a land pattern. For example, the ground terminal 11 may include a pattern which projects outward from an outer circumference of the split-ring conductor 12. For example, the ground terminal 11 may include an exposed pattern formed by partially removing a coat of the split-ring conductor 12. For example, the ground terminal 11 may be electrically connectable with a ground pattern via soldering, pressure joining, etc. For example, the split-ring conductor 12 and the ground terminal 11 may be formed by bending a piece which is cut out from one conductive board by a laser, etc. to have a developed view shape. For example, the part of the ground terminal 11, which extends in the D-direction, may be straight or curved in the D-direction.

For example, the feeding terminal 15 may be a terminal for feeding RF signals to the split-ring conductor 12. For example, the feeding terminal 15 may be electrically connected with a part of the split-ring conductor 12, which is in the vicinity of the split 13. For example, the feeding terminal 15 may extend from a connection point with the split-ring conductor 12 toward a side which is opposite across the opening 14. For example, the feeding terminal 15 may be formed of a wire such as a transmission line. For example, the feeding terminal 15 may be formed of a metal plate. For example, the split-ring conductor 12 and the metal plate part of the feeding terminal 15 may be formed by cutting out them from one conductive board by a laser, etc.

In an aspect of the present disclosure, for example, when the ground terminal 11 is connected to a ground pattern of a board, a current depending on the fed RF signals can flow through the split-ring conductor 12 and a ground pattern. In an aspect of the present disclosure, for example, the current especially easily flows through edges of the ground pattern so that characteristics as an antenna are easily exhibited. From the above, according to an aspect of the present disclosure, for example, a split-ring resonator can be distributed as a single component and can be flexibly combined in accordance with design requirements. Thus, according to an aspect of the present disclosure, for example, a split-ring resonator can be used as a component.

In an aspect of the present disclosure, for example, since at least two of the ground terminals 11 exist at corners on a split side, the current easily flows through edges of a ground pattern so that characteristics as an antenna are easily exhibited.

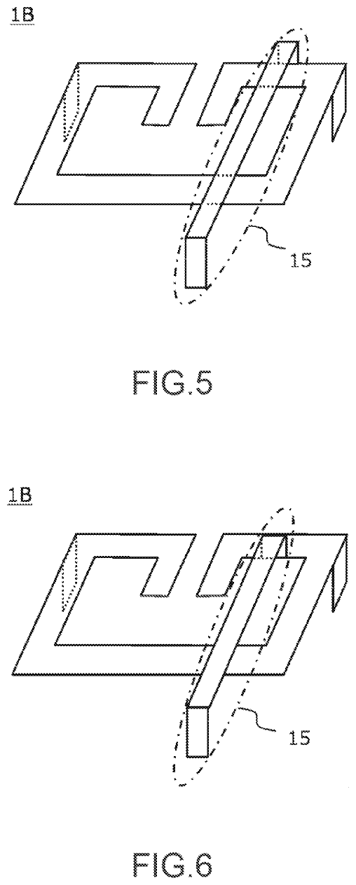

For example, a split-ring resonator according to an aspect of the present disclosure, for example, the split-ring resonator 1A, etc. or their modifications, may comprise the feeding terminal 15, and the feeding terminal 15 may include a part extending in the D-direction. FIG. 4 is an example of a split-ring resonator according to an aspect of the present disclosure. FIG. 5 is an example of a split-ring resonator according to an aspect of the present disclosure. FIG. 6 is an example of a split-ring resonator according to an aspect of the present disclosure.

For example, the feeding terminal 15 may extend from a connection point with the split-ring conductor 12 toward a side which is opposite across the opening 14. For example, the feeding terminal 15 may extend from a connection point with the split-ring conductor 12 over the opening 14. For example, a lead 151 may be in the opening 14 or may be out of the opening 14. For example, the feeding terminal 15 may be formed by bending a piece which is cut out from one conductive board by a laser, etc. to have a developed view shape. For example, the split-ring conductor 12 and the feeding terminal 15 may be formed by bending a piece which is cut out from one conductive board by a laser, etc. to have a developed view shape. For example, the part of the feeding terminal 15 which extends in the D-direction may be straight or curved in the D-direction. For example, the part of the feeding terminal 15, which extends in the D-direction, may be electrically connected with a ground pattern via soldering, pressure joining, etc.

From the above, in an aspect of the present disclosure, for example, when the ground terminal 11 is connected to a board, the positions which support the split-ring conductor 12 increase in number. Therefore, according to an aspect of the present disclosure, for example, manufacturing accuracy is improved.

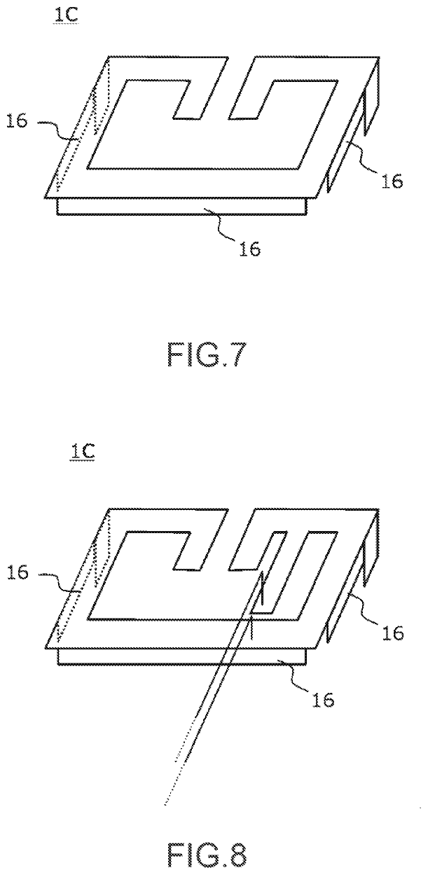

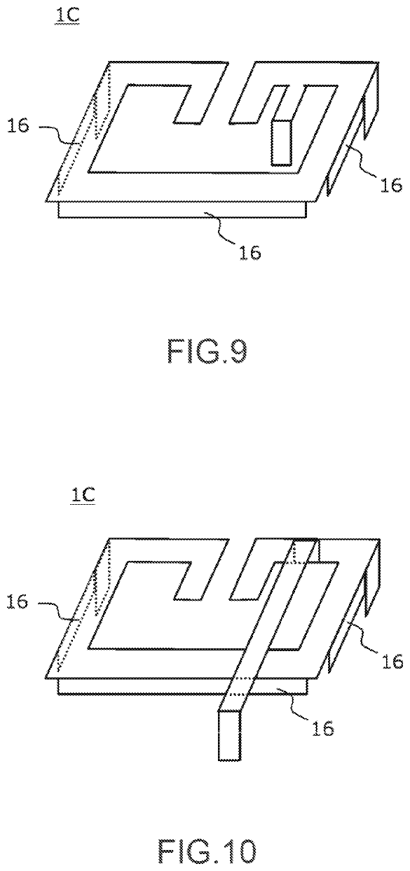

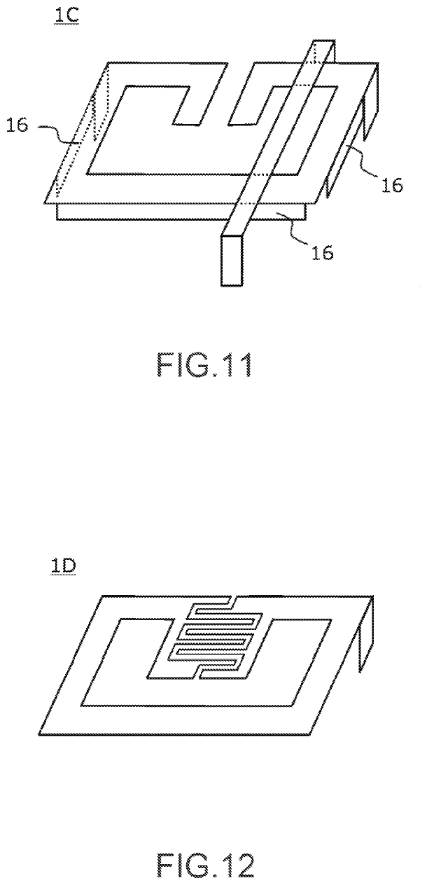

For example, a split-ring resonator according to an aspect of the present disclosure, for example, the split-ring resonator 1A, 1B, etc. or their modifications, may comprise a support 16 located at a part of the split-ring conductor 12, which is not in the vicinity of the split 13, wherein the support 16 may be arranged on an area where the ground terminal 11 extends from the split-ring conductor 12. FIG. 7 is an example of a split-ring resonator according to an aspect of the present disclosure. FIG. 8 is an example of a split-ring resonator according to an aspect of the present disclosure. FIG. 9 is an example of a split-ring resonator according to an aspect of the present disclosure. FIG. 10 is an example of a split-ring resonator according to an aspect of the present disclosure. FIG. 11 is an example of a split-ring resonator according to an aspect of the present disclosure.

For example, the support 16 may be formed of a metal plate. For example, the split-ring conductor 12 and the support 16 may be formed by bending a piece which is cut out from one conductive board by a laser, etc. to have a developed view shape. For example, the support 16 may be straight or curved in the D-direction. For example, the width of the support 16 may be any size and may be short or long. For example, the length of the support 16 in the D-direction may be shorter than, substantially equal to, or longer than that of the ground terminal 11 or the feeding terminal 15. For example, the support 16 may be integrally formed with the ground terminal 11. For example, the support 16 may be electrically connected with a ground pattern via soldering, pressure joining, etc. For example, when the split-ring conductor 12 has a C-like shape along a rectangular ring, for example, the support 16 may be arranged on three sides which are other than a side on which the split exists.

From the above, in an aspect of the present disclosure, for example, when the ground terminal 11 is connected to a board, the positions which support the split-ring conductor 12 increase in number. Therefore, according to an aspect of the present disclosure, for example, manufacturing accuracy is improved.

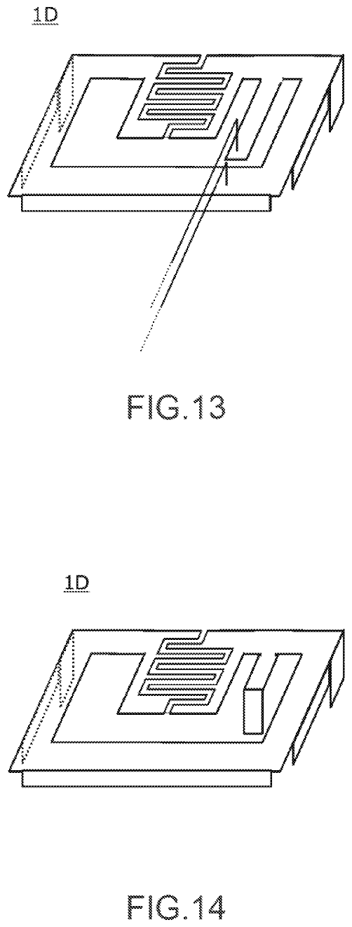

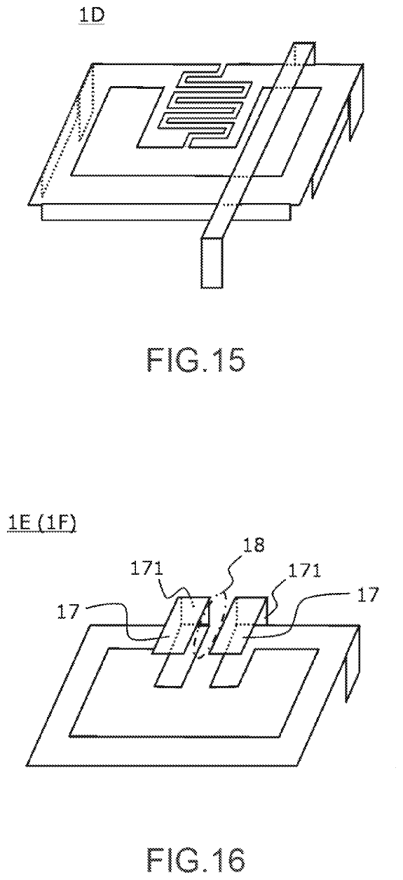

For example, in a split-ring resonator according to an aspect of the present disclosure, for example, in the split-ring resonator 1A, 1B, 1C, etc. or their modifications, the split 13 may have a meander shape. FIG. 12 is an example of a split-ring resonator according to an aspect of the present disclosure. FIG. 13 is an example of a split-ring resonator according to an aspect of the present disclosure. FIG. 14 is an example of a split-ring resonator according to an aspect of the present disclosure. FIG. 15 is an example of a split-ring resonator according to an aspect of the present disclosure.

The wording of the meander shape includes concept which is specified by the wordings such as a zigzag shape, a comb tooth shape, and a shape based on an interdigital structure. For example, a meander shape is formed of a combination of a straight line, a curved line, a zigzag line, etc.

From the above, in an aspect of the present disclosure, since the area of parts of the split-ring conductor 12, which are opposite to each other across the split 13, can be increased, the capacitance of a split-ring resonator can be increased, for example. Therefore, in an aspect of the present disclosure, since the capacitance can be increased, the inductance can be decreased for a certain resonance frequency, for example. Thus, according to an aspect of the present disclosure, the split-ring conductor 12 can be reduced in size, for example.

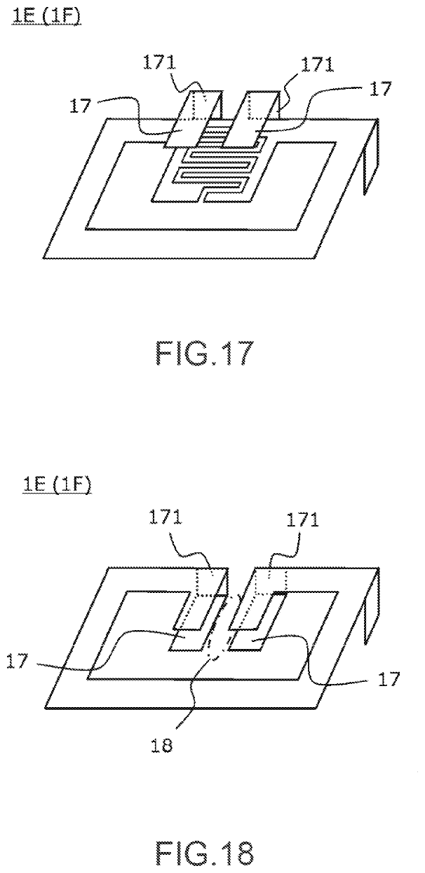

For example, a split-ring resonator according to an aspect of the present disclosure, for example, the split-ring resonator 1A, 1B, 1C, 1D, etc. or their modifications, may comprise a conductor 17, and the conductor 17 may be divided by a split 18, may belong to another plane which faces the plane P, and may be electrically connected, via a conductor 171 extending in the D-direction, to a part of the split-ring conductor 12, which is in the vicinity of the split 13. FIG. 16 is an example of a split-ring resonator according to an aspect of the present disclosure. FIG. 17 is an example of a split-ring resonator according to an aspect of the present disclosure. FIG. 18 is an example of a split-ring resonator according to an aspect of the present disclosure.

For example, the conductor 17 may be formed of a metal plate. For example, the conductor 17 may have a shape substantially same as or different from a shape of a part of the split-ring conductor 12, which is in the vicinity of the split 13.

For example, the conductor 171 may be formed of a metal plate. For example, the conductor 171 may extend in the area of the split-ring conductor 12, where the ground terminal 11 extends when viewed from the split-ring conductor 12. For example, the conductor 171 may extend in another area of the split-ring conductor 12, which is opposite to the area where the ground terminal 11 extends when viewed from the split-ring conductor 12.

For example, the split 18 may be filled with nothing. For example, the split 18 may be filled with resin. For example, the split 18 may have any shape. For example, the split 18 may have a shape such as a straight line, a curved line, or a zigzag line.

For example, nothing may be filled between the conductor 17 and a part of the split-ring conductor 12, which is in the vicinity of the split 13. For example, resin may be filled between the conductor 17 and a part of the split-ring conductor 12, which is in the vicinity of the split 13.

From the above, in an aspect of the present disclosure, the capacitance of a split-ring resonator can be increased, for example. Therefore, in an aspect of the present disclosure, since the capacitance can be increased, the inductance can be decreased for a certain resonance frequency, for example. Thus, according to an aspect of the present disclosure, the split-ring conductor 12 can be reduced in size, for example.

For example, in a split-ring resonator according to an aspect of the present disclosure, for example, in a split-ring resonator 1E, etc. or their modifications, the conductor 171 may be a part formed by bending an end of at least one of the conductor 17 and a part of the split-ring conductor 12, which is in the vicinity of the split 13.

For example, the conductor 17 and the lead 171 may be formed by bending a piece which is cut out from one conductive board by a laser, etc. to have a developed view shape. For example, the split-ring conductor 12 and the lead 171 may be formed by bending a piece which is cut out from one conductive board by a laser, etc. to have a developed view shape. For example, the split-ring conductor 12, the lead 171 and the conductor 17 may be formed by bending a piece which is cut out from one conductive board by a laser, etc. to have a developed view shape. For example, the lead 171 may be straight or curved in the D-direction.

From the above, in an aspect of the present disclosure, for example, it is not necessary to glue the conductors together. Therefore, according to an aspect of the present disclosure, for example, manufacturing accuracy is improved.

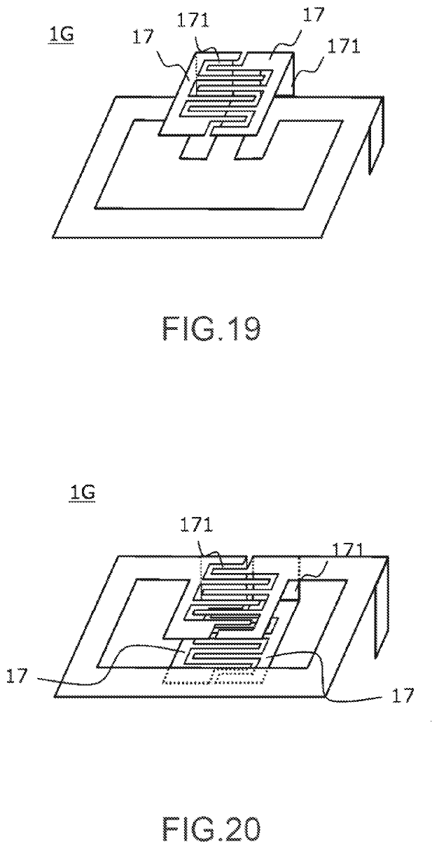

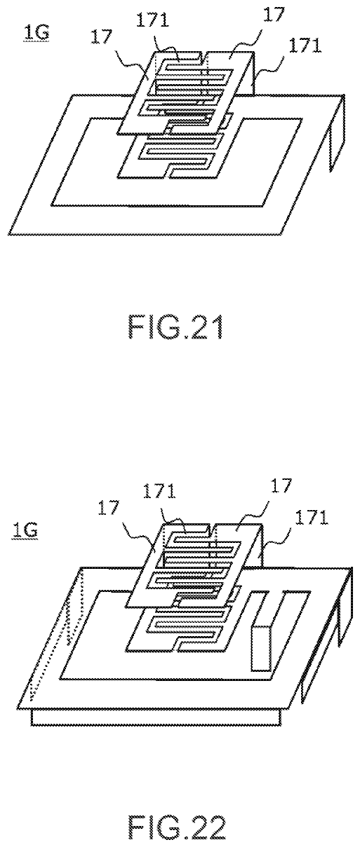

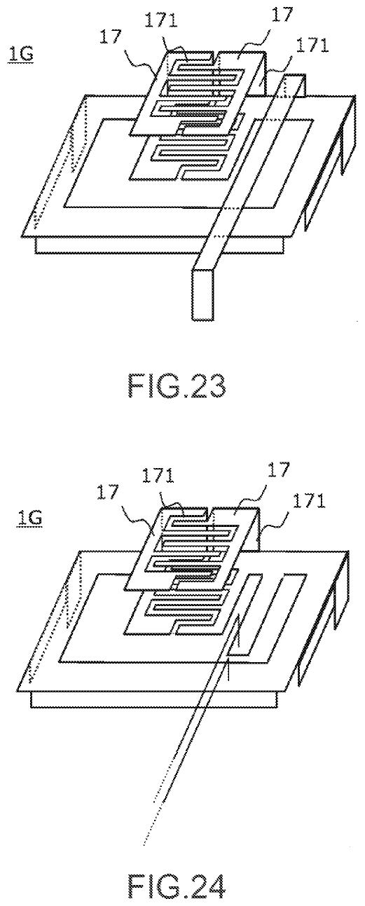

For example, in a split-ring resonator according to an aspect of the present disclosure, for example, in the split-ring resonator 1E, 1F, etc. or their modifications, the split 18 may have a meander shape. FIG. 19 is an example of a split-ring resonator according to an aspect of the present disclosure. FIG. 20 is an example of a split-ring resonator according to an aspect of the present disclosure. FIG. 21 is an example of a split-ring resonator according to an aspect of the present disclosure. FIG. 22 is an example of a split-ring resonator according to an aspect of the present disclosure. FIG. 23 is an example of a split-ring resonator according to an aspect of the present disclosure. FIG. 24 is an example of a split-ring resonator according to an aspect of the present disclosure.

From the above, in an aspect of the present disclosure, the capacitance of a split-ring resonator can be increased, for example. Therefore, in an aspect of the present disclosure, since the capacitance can be increased, the inductance can be decreased for a certain resonance frequency, for example. Thus, according to an aspect of the present disclosure, the split-ring conductor 12 can be reduced in size, for example.

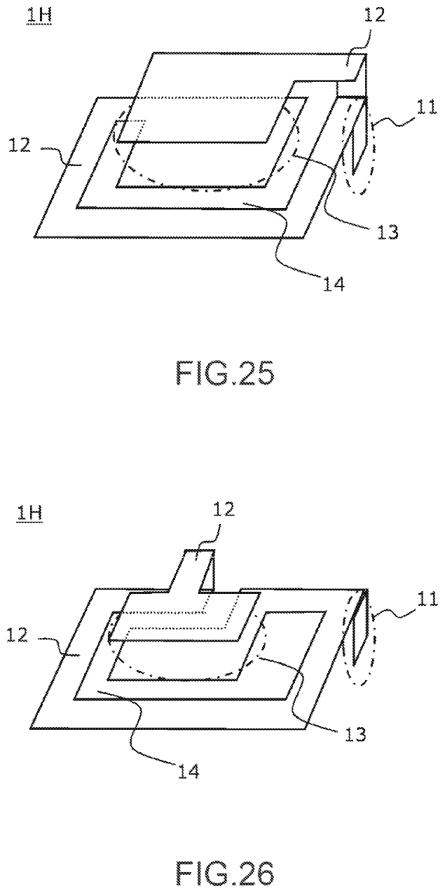

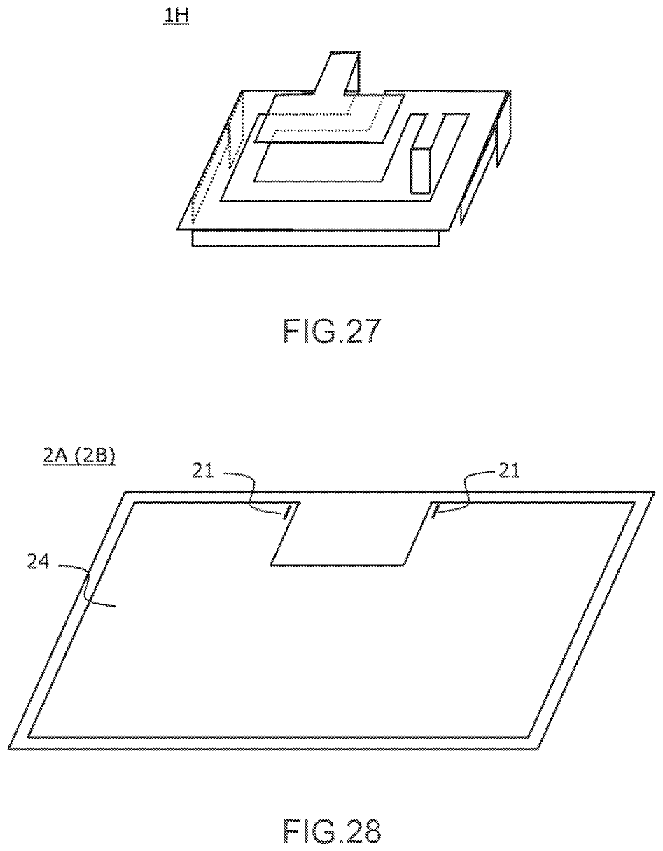

For example, in a split-ring resonator according to an aspect of the present disclosure, for example, in the split-ring resonator 1A, 1B, 1C, 1D, etc. or their modifications, the plane P may be a plane P1 and a plane P2 facing each other, and the split 13 may be sandwiched by the plane P1 and the plane P2 and is formed in the D-direction. FIG. 25 is an example of a split-ring resonator according to an aspect of the present disclosure. FIG. 26 is an example of a split-ring resonator according to an aspect of the present disclosure. FIG. 27 is an example of a split-ring resonator according to an aspect of the present disclosure.

For example, the split-ring conductor 12 may be formed by bending a piece which is cut out from one conductive board by a laser, etc. to have a developed view shape.

For example, a meander shape may include a shape formed of combination of irregularities on two surfaces.

For example, in an instance where the split 13 is formed into a meander shape, it may be formed to have a meander shape when seen along a direction perpendicular to the D-direction. For example, a meander shape may include a shape formed of combination of irregularities on two surfaces. For example, in an instance where the split 13 is formed into a meander shape, the meander shape may be formed of combination of irregularities on conductive surfaces of the split-ring conductor 12, which face each other across the split 13.

From the above, in an aspect of the present disclosure, the capacitance of a split-ring resonator can be increased, for example. Therefore, in an aspect of the present disclosure, since the capacitance can be increased, the inductance can be decreased for a certain resonance frequency, for example. Thus, according to an aspect of the present disclosure, the split-ring conductor 12 can be reduced in size in a direction perpendicular to the D-direction, for example.

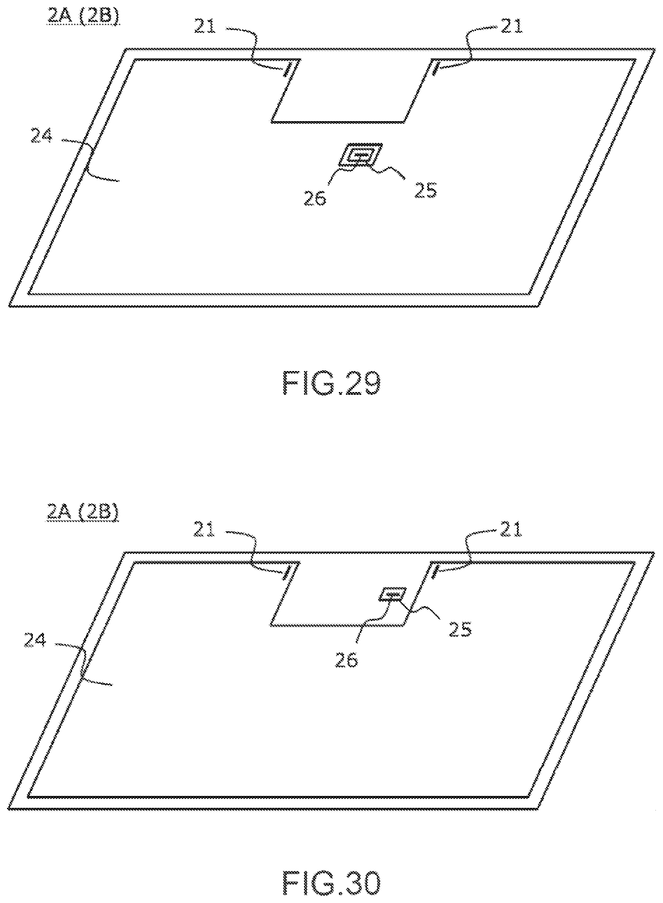

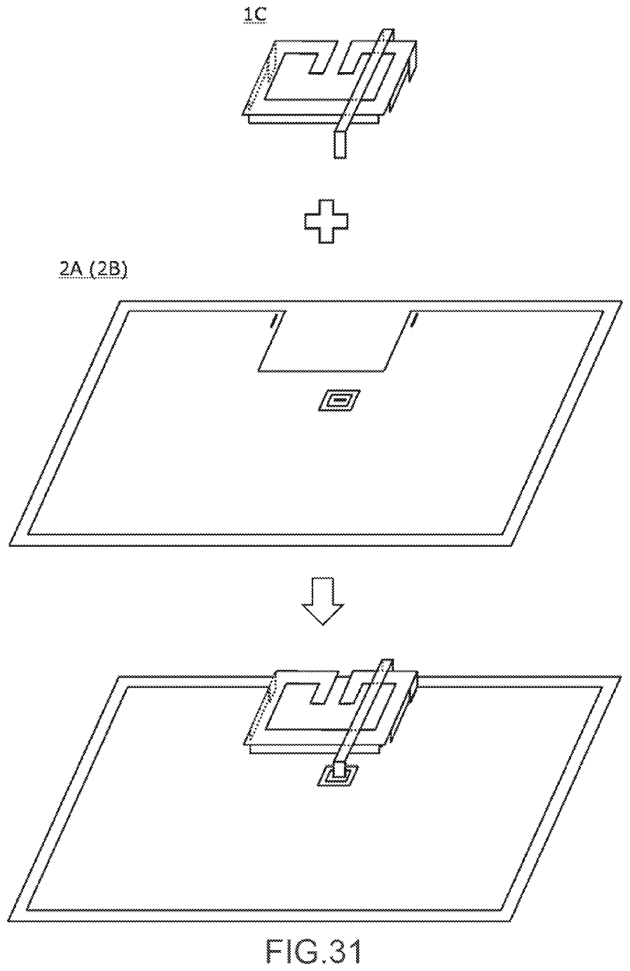

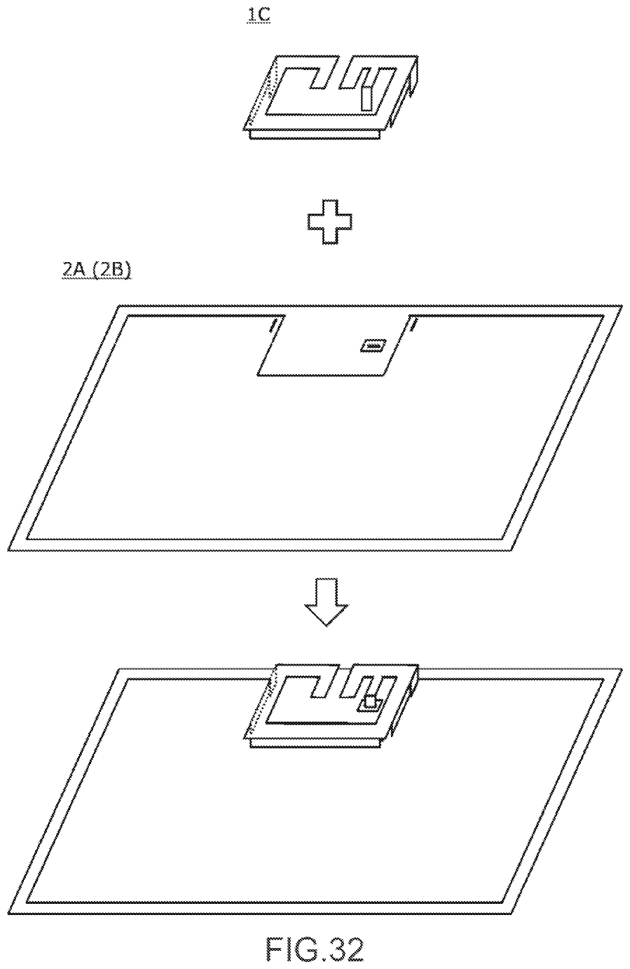

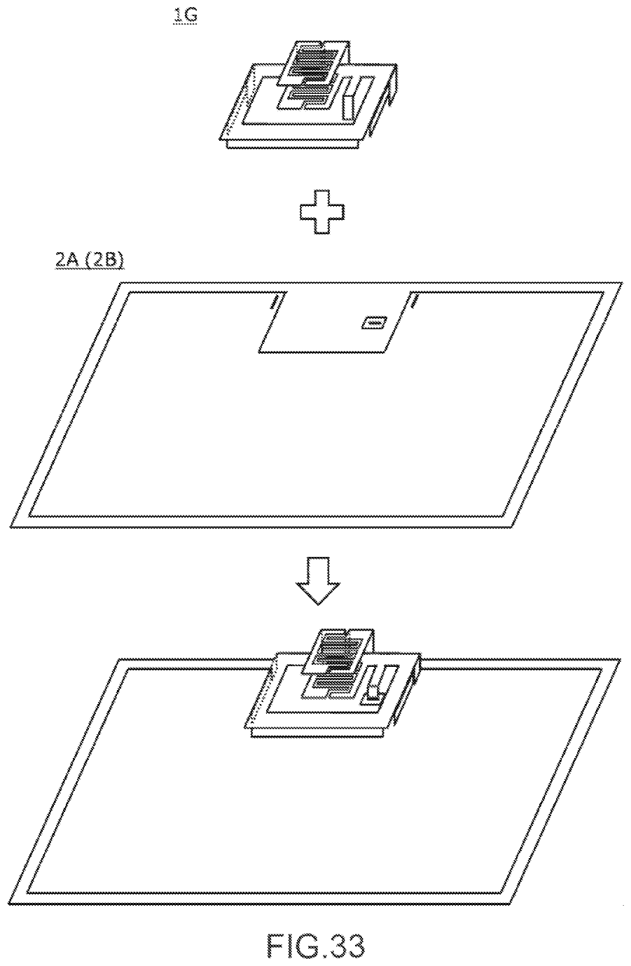

For example, a board according to an aspect of the present disclosure may comprise a terminal 21 which corresponds to the ground terminal 11 of a split-ring resonator according to an aspect of the present disclosure, for example, the split-ring resonator 1A, 1B, 1C, 1D, 1E, 1F,1G, 1H, etc. or their modifications. For example, in a board according to an aspect of the present disclosure, for example, in a board 2A, etc. or their modifications, no conductor may exist on a portion of the board, the portion of the board facing a part of the split-ring conductor 12, which is in the vicinity of the split 13, when the ground terminal 11 is connected to the terminal 21. FIG. 28 is an example of a board according to an aspect of the present disclosure. FIG. 29 is an example of a board according to an aspect of the present disclosure. FIG. 30 is an example of a board according to an aspect of the present disclosure. FIG. 31 is an example of a connection configuration of an example of a board according to an aspect of the present disclosure with an example of a split-ring resonator according to an aspect of the present disclosure. FIG. 32 is an example of a connection configuration of an example of a board according to an aspect of the present disclosure with an example of a split-ring resonator according to an aspect of the present disclosure. FIG. 33 is an example of a connection configuration of an example of a board according to an aspect of the present disclosure with an example of a split-ring resonator according to an aspect of the present disclosure.

For example, the board 2A may comprise one terminal 21. For example, the board 2A may comprise a plurality of terminals 21. For example, the board 2A may comprise a ground pattern 24. For example, the board 2A may comprise a feeding conductive pattern 25 including a terminal 26 which corresponds to the feeding terminal 15.

For example, the terminal 21 may be connected to the part of the ground terminal 11, which extends in the D-direction. For example, the terminal 21 may correspond to the width of the ground terminal 11. For example, when the support 16 is integrally formed with the ground terminal 11, the width of the terminal 21 may correspond to the width of the ground terminal 11 which is integrally formed with the support.

For example, the feeding conductive pattern 25 may be arranged on a portion of the board, which faces a split-ring resonator according to an aspect of the present disclosure when the ground terminal 11 is connected to the terminal 21. For example, the feeding conductive pattern 25 may be arranged on another portion other than the portion of the board, which faces a split-ring resonator according to an aspect of the present disclosure when the ground terminal 11 is connected to the terminal 21.

From the above, in an aspect of the present disclosure, for example, when the ground terminal 11 is connected to the terminal 21, a current depending on the fed RF signals can flow through the split-ring conductor 12. Therefore, according to an aspect of the present disclosure, for example, a split-ring resonator can be distributed as a single component and can be flexibly combined in accordance with design requirements. Thus, according to an aspect of the present disclosure, for example, a split-ring resonator can be used as a component.

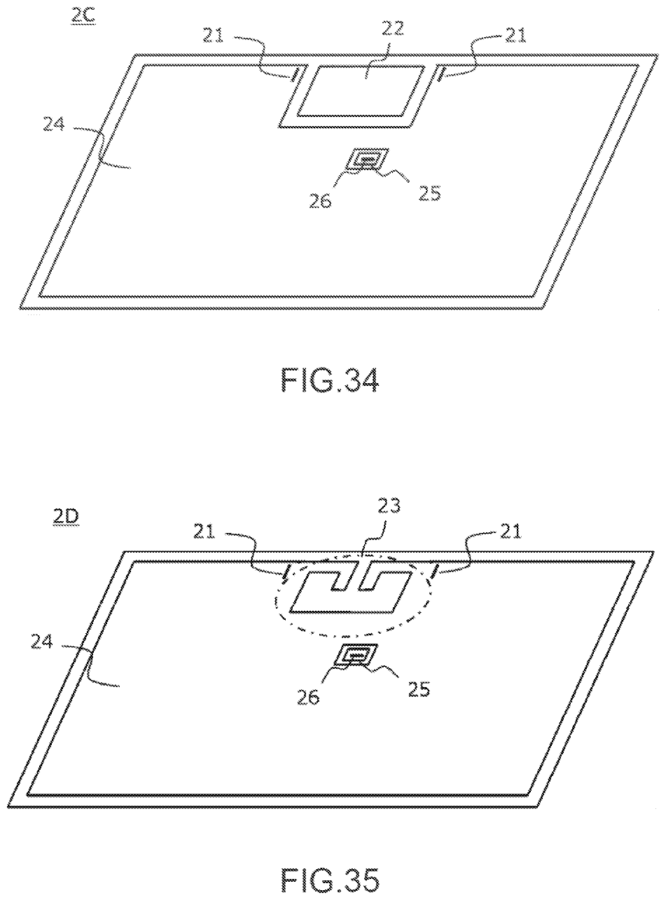

For example, a board according to an aspect of the present disclosure, for example, the board 2A, etc. or their modifications, may comprise a conductor 22 arranged on a portion of the board, the portion of the board facing a part of the split-ring conductor 12, which is in the vicinity of the split 13, when the ground terminal 11 is connected to the terminal 21, and the conductor 22 may be electrically separated from a ground pattern of the board. FIG. 34 is an example of a board according to an aspect of the present disclosure.

From the above, in an aspect of the present disclosure, when the ground terminal 11 is connected to the terminal 21, the capacitance of a split-ring resonator can be increased, for example. Therefore, in an aspect of the present disclosure, since the capacitance can be increased, the inductance can be decreased for a certain resonance frequency, for example. Thus, according to an aspect of the present disclosure, the split-ring conductor 12 can be reduced in size, for example.

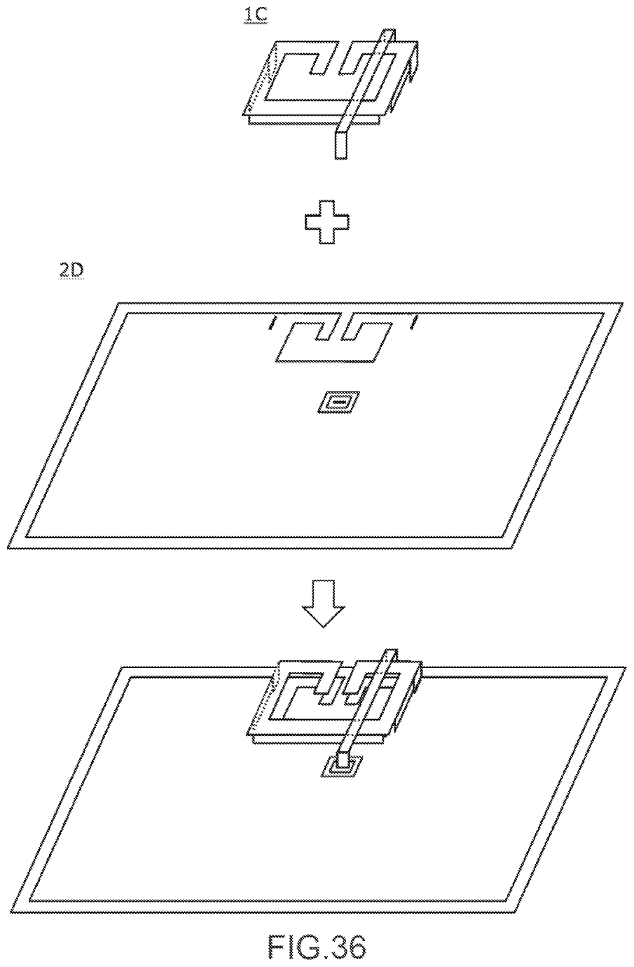

For example, a board according to an aspect of the present disclosure, for example, the board 2A, etc. or their modifications, may comprise a split-ring resonator 23 arranged on a portion of the board, the portion of the board facing a part of the split-ring conductor 12, which is in the vicinity of the split 13, when the ground terminal 11 is connected to the terminal 21. FIG. 35 is an example of a board according to an aspect of the present disclosure. FIG. 36 is an example of a connection configuration of an example of a board according to an aspect of the present disclosure with an example of a split-ring resonator according to an aspect of the present disclosure.

From the above, in an aspect of the present disclosure, when the ground terminal 11 is connected to the terminal 21, the capacitance of a split-ring resonator can be increased, for example. Therefore, in an aspect of the present disclosure, since the capacitance can be increased, the inductance can be decreased for a certain resonance frequency, for example. Thus, according to an aspect of the present disclosure, the split-ring conductor 12 can be reduced in size, for example.

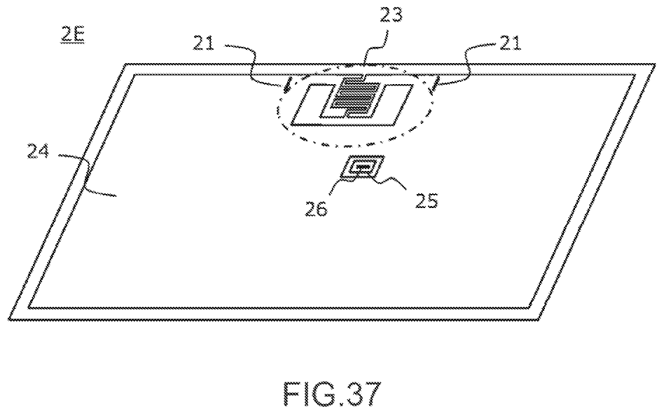

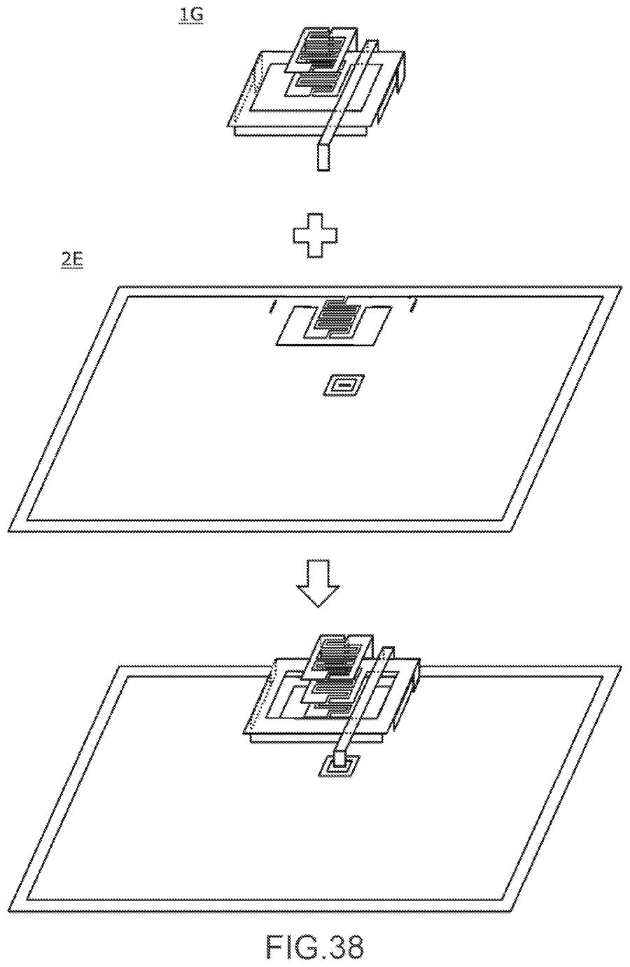

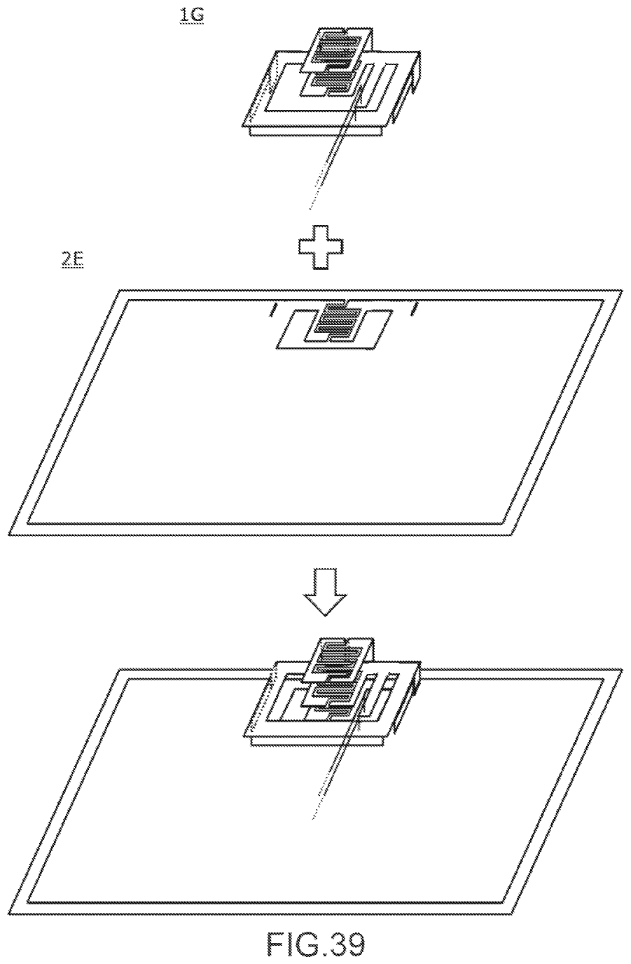

For example, in a board according to an aspect of the present disclosure, for example, in a board 2D, etc. or their modifications, the split-ring resonator 23 may have a meander shape. FIG. 37 is an example of a board according to an aspect of the present disclosure. FIG. 38 is an example of a connection configuration of an example of a board according to an aspect of the present disclosure with an example of a split-ring resonator according to an aspect of the present disclosure. FIG. 39 is an example of a connection configuration of an example of a board according to an aspect of the present disclosure with an example of a split-ring resonator according to an aspect of the present disclosure.

From the above, in an aspect of the present disclosure, when the ground terminal 11 is connected to the terminal 21, the capacitance of a split-ring resonator can be increased, for example. Therefore, in an aspect of the present disclosure, since the capacitance can be increased, the inductance can be decreased for a certain resonance frequency, for example. Thus, according to an aspect of the present disclosure, the split-ring conductor 12 can be reduced in size, for example.

Although the present invention has been described above with reference to the embodiments, the present invention is not limited by the description described above. Various modifications, which can be understood by a skilled person in the art within the scope of the invention, can be applied to the configuration and details of the present invention.

The present application is based on and claims priority to a Japanese patent application of JP2018-106627 filed on Jun. 4, 2018 before the Japan Patent Office, the content of which is entirely incorporated herein.

A part or all of the embodiments described above can be described in the following Additional Notes but are not limited to the following.

### (Additional Note 1)

A split-ring resonator comprising a ground terminal separated from a ground pattern, wherein the ground terminal includes a part extending in a substantially perpendicular direction relative to a plane which belongs to a split-ring like conductive portion of the split-ring resonator.

### (Additional Note 2)

The split-ring resonator as described in Additional Note 1, wherein:

the split-ring resonator comprises a feeding terminal; and

the feeding terminal includes a part extending in the substantially perpendicular direction.

### (Additional Note 3)

The split-ring resonator as described in Additional Note 1 or 2, wherein the split-ring resonator comprises a support located at a part of a split-ring like conductive portion of the split-ring resonator, which is not in the vicinity of a first split of the split-ring resonator, wherein the support is arranged on an area where the ground terminal extends from the split-ring like conductive portion of the split-ring resonator.

### (Additional Note 4)

The split-ring resonator as described in one of Additional Notes 1 to 3, wherein a first split of the split-ring resonator has a meander shape

### (Additional Note 5)

The split-ring resonator as described in one of Additional Notes 1 to 4, wherein:

the split-ring resonator comprises a second conductor; and

the second conductor is divided by a second split, belongs to another plane which faces the aforementioned plane, and is electrically connected, via a third conductor extending in the substantially perpendicular direction, to a part of a split-ring like conductive portion of the split-ring resonator, which is in the vicinity of a first split of the split-ring resonator.

### (Additional Note 6)

The split-ring resonator as described in Additional Note 5, wherein the third conductor is a part formed by bending an end of at least one of the second conductive portion and a part of a split-ring like conductive portion of the split-ring resonator, which is in the vicinity of a first split of the split-ring resonator.

### (Additional Note 7)

The split-ring resonator as described in Additional Note 5 or 6, wherein the second split has a meander shape.

### (Additional Note 8)

The split-ring resonator as described in one of Additional Notes 1 to 4, wherein:

the aforementioned plane is two planes facing each other; and

a first split of the split-ring resonator is sandwiched by the two planes facing each other and is formed in the substantially perpendicular direction.

### (Additional Note 9)

A board comprising a terminal which corresponds to the ground terminal of the split-ring resonator as described in one of Additional Notes 1 to 8.

### (Additional Note 10)

The board as described in Additional Note 9, wherein no conductor exits on a portion of the board, the portion of the board facing a part of a split-ring like conductive portion of the split-ring resonator, which is in the vicinity of a first split of the split-ring resonator, when the ground terminal is connected to the terminal.

### (Additional Note 11)

The board as described in Additional Note 9, wherein:

the board comprises a fourth conductor arranged on a portion of the board, the portion of the board facing a part of a split-ring like conductive portion of the split-ring resonator, which is in the vicinity of a first split of the split-ring resonator, when the ground terminal is connected to the terminal; and

the fourth conductor is electrically separated from a ground pattern of the board.

### (Additional Note 12)

The board as described in Additional Note 9, wherein the board comprises a second split-ring resonator arranged on a portion of the board, the portion of the board facing a part of a split-ring like conductive portion of the split-ring resonator, which is in the vicinity of a first split of the split-ring resonator, when the ground terminal is connected to the terminal.

### (Additional Note 13)

The board as described in Additional Note 12, wherein a split of the second split-ring resonator has a meander shape.

### INDUSTRIAL APPLICABILITY

For example, the split-ring resonator, etc. according to the present disclosure are applicable as an antenna used in a wireless communication device.

### REFERENCE SIGNS LIST

1A, 1B, 1C, 1D, 1E, 1F, 1G, 1H: split-ring resonator
11: ground terminal
12: split-ring conductor
13: split
14: opening
15: feeding terminal
16: support
17: conductor
171: conductor
18: split
2A, 2B, 2C, 2D, 2E: board
21: terminal
22: conductor
23: split-ring resonator
24: ground pattern
25: feeding conductive pattern
26: terminal

1: A split-ring resonator comprising a first split and a ground terminal separated from a ground pattern, wherein the ground terminal includes a part extending in a substantially perpendicular direction relative to a plane which belongs to a split-ring like conductive portion of the split-ring resonator.

2: The split-ring resonator as recited in claim 1, wherein:
the split-ring resonator comprises a feeding terminal; and
the feeding terminal includes a part extending in the substantially perpendicular direction.

3: The split-ring resonator as recited in claim 1, wherein the split-ring resonator comprises a support located at a part of the split-ring like conductive portion of the split-ring resonator, which is not in the vicinity of the first split of the split-ring resonator, wherein the support is arranged on an area where the ground terminal extends from the split-ring like conductive portion of the split-ring resonator.

4: The split-ring resonator as recited in claim 1, wherein the first split of the split-ring resonator has a meander shape.

5: The split-ring resonator as recited in claim 1, wherein:
the split-ring resonator comprises a second conductor; and
the second conductor is divided by a second split, belongs to another plane which faces the aforementioned plane, and is electrically connected, via a third conductor extending in the substantially perpendicular direction, to a part of the split-ring like conductive portion of the split-ring resonator, which is in the vicinity of the first split of the split-ring resonator.

6: The split-ring resonator as recited in claim 5, wherein the third conductor is a part formed by bending an end of at least one of the second conductive portion and a part of the split-ring like conductive portion of the split-ring resonator, which is in the vicinity of the first split of the split-ring resonator.

7: The split-ring resonator as recited in claim 5, wherein the second split has a meander shape.

8: The split-ring resonator as recited claim 1, wherein:
the aforementioned plane is two planes facing each other; and
the first split of the split-ring resonator is sandwiched by the two planes facing each other and is formed in the substantially perpendicular direction.

9: A board comprising a terminal which corresponds to the ground terminal of the split-ring resonator as recited in claim 1.

10: The board as recited in claim 9, wherein no conductor exits on a portion of the board, the portion of the board facing a part of the split-ring like conductive portion of the split-ring resonator, which is in the vicinity of the first split of the split-ring resonator, when the ground terminal is connected to the terminal.

11: The board as recited in claim 9, wherein:
the board comprises a fourth conductor arranged on a portion of the board, the portion of the board facing a part of the split-ring like conductive portion of the split-ring resonator, which is in the vicinity of the first split of the split-ring resonator, when the ground terminal is connected to the terminal; and
the fourth conductor is electrically separated from a ground pattern of the board.

12: The board as recited in claim 9, wherein the board comprises a second split-ring resonator arranged on a portion of the board, the portion of the board facing a part of the split-ring like conductive portion of the split-ring resonator, which is in the vicinity of the first split of the split-ring resonator, when the ground terminal is connected to the terminal.

13: The board as recited in claim 12, wherein a split of the second split-ring resonator has a meander shape.
